(19) United States
(12) Patent Application Publication
(10) Pub. No.: US 2026/0092493 A1
(43) Pub. Date: Apr. 2, 2026

(54) THERMOPLASTIC SPACER COHESIVELY BONDED INSULATED GLASS UNIT, COHESIVE BOND ASSEMBLY METHOD AND COHESIVE BOND ASSEMBLY LINES

(71) Applicant: Erdman Automation Corporation, Princeton, MN (US)

(72) Inventor: Morgan W. Donohue, North Oaks, MN (US)

(21) Appl. No.: 19/318,034

(22) Filed: Sep. 3, 2025

Related U.S. Application Data
(60) Provisional application No. 63/700,259, filed on Sep. 27, 2024.

(51) Int. Cl. E06B 3/663; E06B 3/673

(52) U.S. Cl. CPC E06B 3/66328; E06B 3/6733; E06B 3/67386; E06B 3/67369; E06B 3/67373

(57) ABSTRACT

An insulated glass unit, including two spacer applied lites including a first lite and a second lite. Each of the lites has a strand of thermoplastic spacer material applied thereto proximate and inset from a perimeter of each of the spacer applied lites. The two strands include a first strand applied to the first lite and a second strand applied to the second lite. The first strand and the second strand are joined together and cohesively bonded by contact between the first strand and the second strand thereby forming a primary seal of the insulated glass unit. The invention also includes methods of making such insulated glass units and manufacturing lines that enable making such insulated glass units.

### CLAIM TO PRIORITY

This application claims the benefit of U.S. Provisional Application 63/700,259, filed Sep. 27, 2024, entitled “THERMOPLASTIC SPACER COHESIVELY BONDED INSULATED GLASS UNIT, COHESIVE BOND ASSEMBLY METHOD AND COHESIVE BOND ASSEMBLY LINES,” the entire contents of which is incorporated herein by reference.

### TECHNICAL FIELD

The invention relates to production of insulated glass units. More specifically, the invention relates to production of insulated glass units manufactured with thermoplastic spacer materials.

### BACKGROUND

Insulated glass is heavily utilized in modern residential and commercial construction. In many areas of the country, it is required by building code as an energy conservation measure. A single pane of glass alone has very little insulating value. Multi-pane insulated glass windows have much greater insulating value. Insulated glass units generally include at least two panes of glass having identical shapes. Sealants and adhesives are used to bond the glass panes to a perimeter spacer which separates the two panes of glass. The entire perimeter including the two panes of glass and the spacer are sealed to one another to eliminate movement of ambient air into the space between the two panes of glass.

The space is generally filled with dehydrated air or more commonly another gas such as argon, xenon or krypton. Sulfur hexafluoride is also used for gas filling. The filling of insulated glass units with argon or another gas that is not air has been found to increase the energy efficiency of the insulated glass units markedly. Some insulated glass units includes three panes of glass with two intervening spaces which are similarly filled with argon or another gas other than air and then edge sealed.

The spacer in an insulated glass unit is usually inset from the peripheral edges of the glass panes leading to a trough shaped space bounded on two sides by the glass panes and on one side by the spacer. In the manufacturing of some insulated glass units, this space is filled with an adhesive sealant which forms the so called, secondary seal of the insulated glass unit.

Recently, other primary sealing technologies have been developed. These edge sealing technologies utilize a primary seal that stands alone and produce an insulated glass unit that does not include a secondary seal. This may result in faster production and reduced cost for insulated glass units though the units may also have shorter lives and be useful in a narrower range of climatic conditions.

Traditionally, spacers have been made from rigid metallic materials or sometimes rigid plastic materials. Later spacers have been made from flexible metal or flexible plastic materials that can be applied from storage rolls.

Thermoplastic spacer materials are formed in place from heated liquid spacer materials that cool and at least partially solidify in place. Thermoplastic spacers, according to the prior art, are extruded onto a surface of a first glass lite and then a second glass lite is applied to an opposing side of the thermoplastic spacer material which then adheres to the surface of the second glass lite. This second lite is often referred to as a topping lite.

In production of insulated glass units with thermoplastic spacer materials, typically a strand made of thermoplastic material is applied by extrusion to a glass lite proximate a perimeter of the glass lite to create a spacer applied lite. A second glass lite, often called a topping lite, that is identical in shape to the first glass lite is then pressed to the thermoplastic spacer material to form a primary sealed insulated glass unit.

If present, a secondary seal may be applied using a variety of different adhesive sealants. These include time setting sealants, such as silicones or butyl rubber sealants. Less commonly, two-part sealants utilizing a resin and a catalyst to polymerize the resin are utilized. More commonly in modern manufacturing, hot melt adhesive sealants are used. Hot melt adhesive sealants are generally applied in a liquid state or semiliquid state at a temperature of approximately 350° F. and harden upon cooling to ambient temperature.

In high volume manufacturing facilities, the secondary seal is commonly applied by fully automated equipment in which a computer controlled robotic sealant applying head is moved around the peripheral edges of the insulated glass unit under computer control and applies the sealant to the edge or edges of the insulated glass unit. Fully automated secondary edge sealing equipment of this sort can apply the secondary seal to very large numbers of insulating glass units in a production run. Typically, the insulated glass units in these circumstances are produced in large runs of similar units.

The process of manufacturing insulated glass units generally includes infeed of glass panes or lites into a washing unit that cleans both surfaces of each pane and, in particular, the surface of each pane that will be on the interior of the insulated glass unit. This is particularly important because, once the insulated glass unit is complete the interior surfaces will be inaccessible to cleaning and any visible dirt is impossible to remove without destruction of the unit. Accordingly, the washing station is generally followed by an inspection station to assure that the panes are sufficiently clean.

In the prior art, panes or lites are then conveyed in tandem fashion to further processing. The panes are usually divided into pairs, each pair including a spacer lite to which a peripheral spacer is applied and which forms the back of the IGU and a topping lite which will ultimately be applied on top of the spacer lite and sealed to the spacer to form the insulated glass unit. According to the prior art generally, the topping lite usually proceeds first in the pair and is followed by the spacer applied lite. When the spacer applied lite reaches a spacer application station, the peripheral spacer primary seal is applied. The spacer lite and the topping lite are both advanced so that the topping lite can be removed from the conveyor. According to the prior art, the topping lite is usually picked up first at the gas press then the spacer applied lite is conveyed in and unit is gas filled and assembled. The primary sealed insulated glass unit is then conveyed to a secondary seal applicator, if secondary sealing is to be done, to apply secondary sealant to the edges bordered by the spacer and the peripheral portions of the lites. The completed IGU is then conveyed to the end of the processing line for transport to next steps.

The ambient environment in which the production of insulated glass units occurs can vary in temperature depending upon the location of the manufacturing facility and weather conditions. The ambient temperature environment can vary but must be at a temperature in which human operators can work in reasonable comfort.

### SUMMARY OF THE INVENTION

For the purposes of this application, the term substantially vertical should be interpreted to mean within zero to fifteen degrees of absolute vertical, for example six degrees from absolute vertical.

According to an example embodiment of the invention, an insulated glass unit is formed from two lites as in traditional insulated glass, however each lite has thermoplastic spacer (TPS) material applied proximate a perimeter thereof. One aspect of the invention is that it facilitates faster application because half of the extrusion is applied to each lite. Applying approximately half of the TPS material speeds application not only because less material is being extruded onto each lite but also because two extrusion machines are making the application instead of one.

One aspect of the invention facilitates preparation of insulated glass units with a thicker air space than is achievable in conventional TPS IGUs. This aspect of the invention facilitates preparation of insulated glass units with a thicker air space, as thermoplastic spacer application is limited in height to approximately twenty millimeters per lite, thereby limiting IGU airspace to that dimension. The height of the spacer material is limited due to the effect of gravity acting to distort the spacer. The distortion becomes greater as the distance from the glass increases. The disclosed methods allow for a doubling of the insulating airspace to approximately forty millimeters thereby improving thermal efficiency. In an example embodiment, a thickness of thirty eight millimeters is expected to be achieved.

Another aspect of the invention facilitates a proper wet out on both lites as there is better adhesion to an applied lite. Better adhesion to the glass is promoted by the pressure and heat of the extruded material upon application as opposed to reduced adhesion to a topping lite upon delayed assembly. Another positive aspect of the invention is the ability to place a grid on the spacer which then is imbedded into the spacer material rather than embedded along the bond line of the glass which is a common source of seal failure.

A method according to an example embodiment of the invention, includes applying thermoplastic spacer material to each of two lites individually and then joining the two lites together so that the thermoplastic spacer material on each of the lites is pressed against the thermoplastic spacer material on the other lite. This then results in an insulated glass unit which demonstrates improved wet out, improved handling qualities and immediate green strength. Wet out is superior between the TPS material and the glass lites because the extrusion of the TPS material directly into contact with the glass surface of each of the glass lites results in superior adhesion as compared to bringing a glass lite into contact with the TPS material a period of time after the TPS material is extruded. In addition, cohesion between the TPS material on one lite with TPS material on the other lite provides superior strength as compared to adhesion between the TPS material on the first lite and a later applied topping lite also with TPS material applied.

In conventional TPS IGU production, there is an unavoidable time lag between the application of TPS material to a first lite by extrusion and the application of a topping lite to complete a primary sealed insulated glass unit. Because of this time delay, the strand of TPS spacer material applied to the first lite will cool and solidify somewhat which means that wetting out between the TPS spacer material that has begun to cool and set and the topping lite is typically less good than the wetting out when the TPS spacer material is applied to the first glass surface. The wetting out or cohesion when pressing together of the TPS applied to both lites is less effected by this cooling and solidifying over time. The two TPS extrusions cohesively bond even when in a significantly cooled state.

According to an example embodiment, each lite receives approximately fifty percent of the TPS spacer application, for example, an amount somewhat greater than fifty percent. This facilitates joining of the two spacer applied lites to create a primary sealed insulated glass unit that is then pressed to a desired thickness. For example, each lite can receive a strand of TPS spacer material extruded to a thickness of approximately sixty percent of the desired ultimate spacer material thickness when the two lites are joined. A roller press or platen press then presses the primary sealed IGU to a desired thickness.

Alternately, according to another example embodiment, each lites may receive an unequal thickness of TPS spacer material. For example, a first spacer applied lite may receive approximately 25% of the desired total spacer thickness while a second spacer applied lite may receive approximately 75% of the total spacer thickness. Each application of TPS material may exceed the proportion of spacer material such that the total thickness applied of spacer material exceeds 100% of the desired total thickness of spacer material to facilitate pressing of the two spacer applied lites to achieve a final desired thickness. Other proportions are, of course, possible, and the examples herein should not be considered limiting. Application of equal amounts of TPS material facilitates maximizing the thickness of an insulated glass unit if a large separation of lites and a resulting thicker air space or space for non-air gas is desired.

Grid anchors may readily be inserted into the spacer material at appropriate places to allow securing of the grid between the two lites prior to final assembly. For example, two grid anchors may be installed at opposing locations proximate two opposite edges of a single lite to which TPS material has been applied and then two more grid anchors may be applied to each of the other adjacent opposing two edges to allow the installation of a three by two grid.

A method according to an example embodiment of the invention facilitates improved grid insertion. Example embodiments of the invention are expected to facilitate easier placement, better holding power, and improved seal structure as two strands of extruded material embed the grid ends or grid anchors. Also as discussed above, this approach eliminates interruption of the bond line of extruded spacer to glass in favor of extrusion to extrusion cohesive bonding that is expected to be far more resistant to leakage.

According to a further example embodiment, a thermoplastic spacer manufacturing line is expected to be configured to produce insulated glass units at a rate of about one each twenty seconds.

According to an example embodiment, this insulated glass unit manufacturing line generally includes in sequence from start to finish, an input conveyor, a lite washing machine, an output conveyor, a dual lane two position shuttle which optionally includes a tilting rear shuttle, an inspection station, a pair of opposed thermoplastic robot spacer applicators (each coupled to and supported by a thermoplastic robot feed system including one pump), a grid application station, a dual lane shuttle which can include a two-position shuttle whose two lanes can move independently or together, a dual lane gas press or two single lane gas presses, either or both of which can tilting gas presses, a dual lane two position shuttle, a queue conveyor, a sealer infeed station, a secondary sealer optionally including two pumps and two movable secondary sealer heads and a sealer outfeed station. The dual lane shuttle includes two lanes each of which is capable of independent movement. The two lanes can be tilted at opposing angles to facilitate transfer of lites to front and rear portions of the line.

The input conveyor, lite washing machine and output conveyor, according to this example embodiment of the invention, are generally conventional and need not be further described here.

The single lane two position shuttle is configured to receive individual glass lites and to deliver them to two separate parallel conveyors for further processing.

The two separate parallel conveyors begin with an inspection station that includes two mutually opposed conveyor stations that allow the glass lites to be approached and inspected from two opposing sides. The two conveyor stations are mutually opposed in that they face opposite directions or are back-to-back so that the glass lites can be accessed from opposing sides of the manufacturing line.

According to the depicted example embodiment, two opposed thermoplastic robot applicators are located on opposing sides of the dual parallel conveyor line. Each thermoplastic robot applicator is supported by a thermoplastic robot feed system including at least one pump which supplies thermoplastic spacer material at a rate appropriate to apply thermoplastic spacer at approximately half thickness to two opposing lites simultaneously.

An optional grid application station follows the dual thermoplastic robot applicators. At this station grid supporting structures may be embedded in the thermoplastic spacer material of at least one and optionally two of the opposing lites.

The dual lane A-frame four position shuttle is configured to receive and handle two thermoplastic spacer applied lites at a time and to deliver them to the dual lane gas press so that each gas press lane receives two spacer applied lites with the spacer applied sides facing inwardly toward each other.

The dual lane gas press is configured to gas fill and pressed together each pair of spacer applied lites to form a completed, pressed and primary sealed insulated glass unit. According to an example embodiment each lane of the dual lane gas press operates alternately to produce the insulated glass units. According to a further example embodiment, a dual lane roller press and gas filling procedure may be used.

Completed insulated glass units are alternately delivered to the two-position shuttle. The two-position shuttle then delivers the primary sealed insulated glass units to the queue conveyor. The queue conveyor then further conveys the primary sealed insulated glass units to the sealer infeed station.

The sealer infeed station then conveys the primary sealed insulated glass units, one at a time, to the secondary sealer which then applies secondary sealant to all of the sides of the primary sealed insulated glass unit.

According to an example embodiment, the secondary sealer utilizes two secondary sealant pumps and two secondary sealant heads to apply secondary sealant to all sides of the primary sealed insulated glass unit. For example, one secondary sealant head may apply secondary sealant to a bottom edge of the primary sealed insulated glass unit while the second secondary sealant head applies secondary sealant to the leading edge, the top edge and the trailing edge of the primary sealed insulated glass unit.

Following secondary sealing at the secondary sealer completed insulated glass units are conveyed to the sealer outfeed station where they can be removed for further processing.

This example embodiment is expected to demonstrate improved wet out of the TPS material to the glass lites as well as to improve handling qualities of the completed insulated glass units based on improved green strength facilitated by application of TPS material to both lites. This example embodiment is expected to facilitate improved grid insertion into insulated glass units as well as positive retention of grid location.

This example embodiment is also expected to provide redundancy in that if one half parallel portion of the conveyor line fails to operate or is taken down for maintenance the other half remains available and operable.

Thermoplastic spacer material is applied to each lite to be joined at approximately one half or slitely more of the total desired thermoplastic spacer material thickness for the to be completed IGU. In addition, glass lites are oriented so that spacer applied sides of the glass lites are positioned opposing each other prior to gas filling and assembly.

According to example embodiments of the invention, dual thermoplastic robot applicators are arranged in parallel separate lines. According to further example embodiments of the invention, dual thermoplastic robot applicators are arranged in tandem one following another. Thus, a first lite is conveyed through a first thermoplastic robot applicator to a second thermoplastic robot applicator and a second lite is delivered to the first thermoplastic robot applicator. Alternate lites are rotated by a rotating shuttle conveyor before traveling to a gas press which may be a tilt gas press.

At this station grid supporting structures may be embedded in the thermoplastic spacer material of at least one and optionally two of the opposing lites.

At least one tilt press is utilized according to some embodiments of the invention. The tilt press includes a tilt platen assembly and a supporting base. The tilt press is configured to receive glass that has thermoplastic spacer material applied to the spacer applied surfaces of both glass lites. Having spacer material applied to both glass lites interferes with handling a topping lite in a traditional manner. The tilt press can also accommodate processing of other types of spacer material as well. The tilt platen assembly tilts about a horizontal tilt axle coupling the tilt platen assembly to the supporting based and moved by at least one linear actuator that further couples the tilt platen assembly to the supporting base. The tilt platen assembly tilts between a first orientation and a second orientation on either side of absolute vertical such as plus or minus twelve degrees. For example, the first orientation and the second orientation may be six degrees on either side of vertical. According to an example embodiment, the at least one linear actuator includes four pneumatic linear actuators, two on either side of the tilt platen assembly. The tilt platen assembly includes a platen press, as known to those skilled in the art. The platen press includes at least one movable platen configured to press an IGU to facilitate cohesive bonding of TPS material on two spacer applied lites. The presses include gas filling presses.

According to another example embodiment, the invention includes a method including loading cohesive bonding spacer applied lite into two tilting gas presses. The tilting gas presses are preceded by a dual position assembly shuttle and followed by a single position sealer shuttle. The assembly shuttle includes two shuttle positions each of which can receive and transport a spacer applied lite received from one of the first or second tilting gas presses. The single position sealer shuttle is configured to receive and transfer a primary sealed insulated glass unit.

The assembly shuttles receive cohesive bonding spacer applied lites from each of a front and a back lane and transfer the spacer applied lites to each of two tilting gas presses while shifting the relative orientation of the spacer applied lites from having the spacer applied sides facing away from each other to having the spacer applied sides facing toward each other in each of the two gas presses.

Second, the shuttles move to load a first tilting gas press which in this example is the front press. The first tilting gas press tilts forward to receive the back line cohesively bonded spacer applied lite.

Third, the back lane shuttle returns to a start position while the first press tilts back to receive a cohesively bonded spacer applied lite from the front lane. The back lane shuttle loads a cohesively bonded spacer applied lite.

Fourth, the second gas press tilts forward to load a back lane cohesive bonding applied lite. At the same time the first gas press offloads a completed primary sealed insulated glass unit to the sealer shuttle. At the same time, the front lane shuttle loads.

Fifth, the second gas press tilts back to receive a front lane spacer applied lite. The second gas press then assembles, gas fills and presses a primary sealed cohesively bonded insulated glass unit and discharges the primary sealed insulated glass unit out to the sealer shuttle.

Sixth, both the assembly shuttle and the sealer shuttle return to their start position to begin the process of loading the first tilting gas press again, and the cycle is repeated.

It is expected that a dual lane multi-applicator embodiment of the invention will demonstrate a twenty second production cycle, that a single lane dual applicator embodiment of the invention will demonstrate a thirty second production cycle and that a single lane single applicator embodiment of the invention will demonstrate a sixty second production cycle. A production cycle represents the time required to process each completed insulated glass unit from start to finish.

### BRIEF DESCRIPTION OF THE DRAWINGS

The drawings included with this application depict example embodiments of manufacturing lines of the invention in a plan view. The drawings also depict sectional views of spacer applied lites as produced according to example embodiments of the invention.

FIG. 1 is a plan view of a thermoplastic spacer (TPS) cohesive bonding insulated glass unit manufacturing line with dual lanes and multiple applicators according to an example embodiment of the invention;

FIG. 2 is a schematic view of two spacer applied lites following TPS application according to an example embodiment of the invention;

FIG. 3 is a schematic sectional view of a dual lane gas press or tilting gas press and spacer applied lites prior to pressing according to an example embodiment;

FIG. 4 is a plan view of a thermoplastic spacer (TPS) cohesive bonding insulated glass unit manufacturing line incorporating a rotating shuttle conveyor with a single lane and a single applicator according to a further example embodiment of the invention;

FIG. 5 is a schematic view of a spacer applied lite following TPS application according to the manufacturing line depicted in FIG. 4;

FIG. 6 is a schematic sectional view of two spacer applied lites in a single lane gas press subassembly as incorporated into the manufacturing line depicted in FIG. 4;

FIG. 7 is a plan view of a TPS cohesive bonding insulated glass unit manufacturing line incorporating a dual Lane A-frame shuttle/grid station and a gas press according to an example embodiment of the invention;

FIG. 8 is a schematic sectional view of spacer applied lites following TPS application comparing a cohesively bonded IGU according to an example embodiment to a conventions TPS IGU;

FIG. 9 is a plan view of a single lane tilting gas press as incorporated into a manufacturing line;

FIG. 10 is an elevational view of a tilting gas press;

FIG. 11 is an elevational side view of the tilting gas press;

FIGS. 12 and 13 are rear perspective views of the tilting gas press;

FIGS. 14-19 are schematic plan views of a portion of a manufacturing line according to an example embodiment of the invention depicting operation of shuttles and two tilting gas presses to mate TPS spacer applied lites to form insulated glass units; and

FIG. 20 ais a plan view of a TPS cohesive bonding insulated glass unit manufacturing line incorporating two thermoplastic spacer applicator robots with associated TPR feed systems and a rotating shuttle conveyor and a gas press according to an example embodiment of the invention.

### DETAILED DESCRIPTION

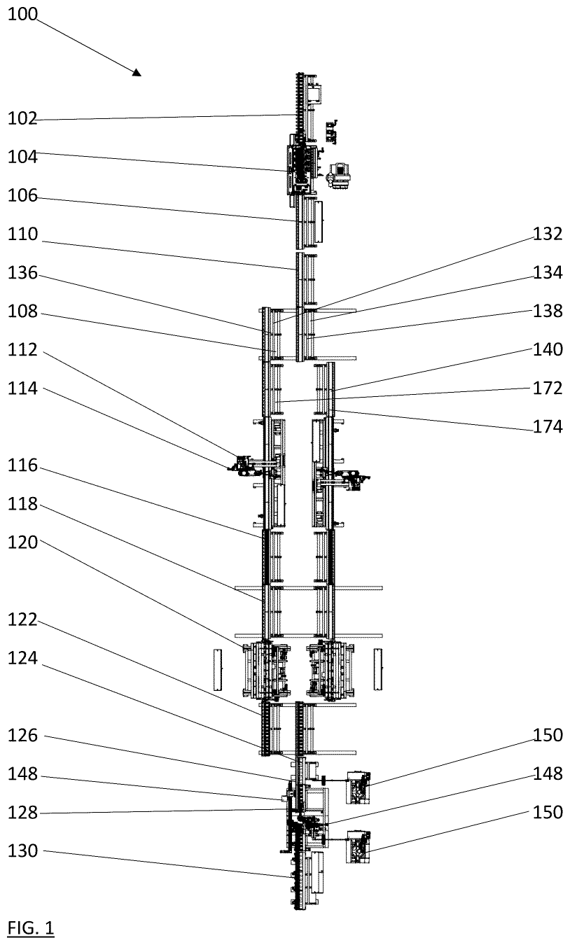

Referring to FIG. 1, according to an example embodiment, cohesive bonding manufacturing line 100 generally includes input conveyor 102, lite washer and dryer 104, output conveyor 106, dual lane shuttle 108, inspection station 110, thermoplastic spacer applicator robots 112, TPR feed systems 114 (not depicted in FIG. 1), grid station 116, independently positioned shuttles 118, dual lane gas press 120, two position shuttle 122, queue conveyor 124, or, sealer infeed 126, secondary sealer 128 and sealer outfeed 130.

Input conveyor 102 is structured to receive glass lites loaded thereon and to convey them to lite washer 104. Input conveyor is generally conventional in design as known to those of skill in the art. and need not be further described here.

Lite washer 104 is structured to receive glass lites from input conveyor 102 and to wash and dry the glass lites. Lite washer is conventional in design and need not be further described here.

Output conveyor 106 conveys washed glass lites from lite washer 104 to dual lane shuttle 108 according to this example embodiment. Glass lites are supported substantially vertically during the conveying operation.

Dual lane shuttle 108 includes a shuttle structured to receive and support glass lites and to shuttle perpendicular to output conveyor 106 between first position 132 and second position 134 to transport alternate glass lites to inspection station 110. Alternate glass lites are delivered to either a front side 136 of inspection station 110 or a rear side 138 of inspection station 110. Lites supported on front side 136 or rear side 138 are tilted in opposing directions so as to be oriented in an A orientation with a six degree tilt. Dual lane shuttle delivers lites to either first lane 172 or second lane 174.

Inspection station 110 supports two lites on opposing sides thereof with the side to which TPS will be applied facing outwardly in opposing directions. Inspection station 110 facilitates inspection of lites for cleanliness prior to application of TPS. As known to those skilled in the art, this is important because the spacer applied side of the lites becomes inaccessible when the insulated glass unit is assembled and cleaning is no longer possible. Inspection station 110 is structured to convey the two lites to thermoplastic spacer applicator robots 112.

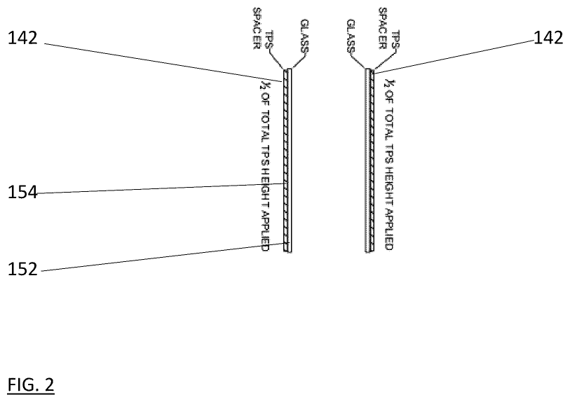

Thermoplastic spacer applicator robots (TPR) 112 are located on opposing sides of lite supporting and conveying structure 140. TPR feed systems 114 each supply thermoplastic spacer in heated liquid form to one of thermoplastic spacer applicator robots 112. Thermoplastic spacer applicator robots 112 are each structured and programmed to apply a bead or strand of thermoplastic spacer material proximate a perimeter of each glass lite. According to this example embodiment of the invention each glass lite thus becomes a spacer applied lite and as depicted in FIG. 2 receives TPS to a height or thickness approximating half of the total thickness of the spacer desired.

Alternately, according to another example embodiment, each lite may receive an unequal thickness of TPS spacer material applied by thermoplastic spacer applicator robots 112. For example, a first spacer applied lite may have approximately 25% of the desired total spacer thickness app while a second spacer applied lite may receive approximately 75% of the total spacer thickness. Each application of TPS spacer material may exceed the proportion of spacer material such that the total thickness applied of spacer material exceeds 100% of the desired total thickness of spacer material to facilitate pressing of the two spacer applied lites to achieve a final desired thickness. Other proportions are, of course, possible, and the examples herein should not be considered limiting.

Grid station 116 optionally follows thermoplastic spacer applicator robots 112 and is structured to receive spacer applied lites from thermoplastic spacer applicator robots 112 and to facilitate installation of internal grids to at least one of the two spacer applied lites. The installation of internal grids may include the installation of grid clips embedded into the TPS material applied to the lite.

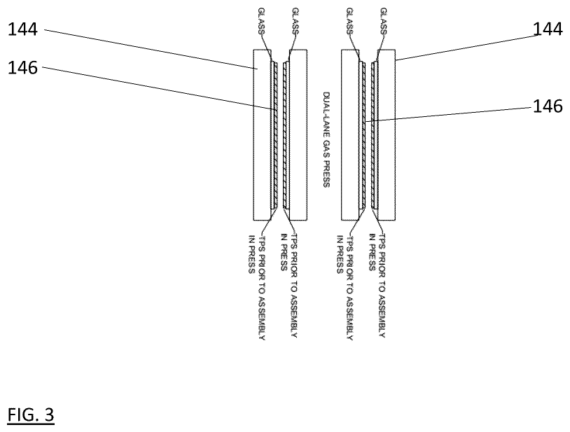

Independently positioned shuttle 118 follows optional grid station 116 or follows thermoplastic spacer applicator robots 112 if grid station is not present. Independently positioned shuttle 118 is structured to receive spacer applied lites from grid station 116 and to shuttle spacer applied lites perpendicularly to distribute the spacer applied lites so that a spacer applied side 142 of each spacer applied lite faces another spacer applied side 142 of another spacer applied lite. The four positions include two positions aligned with each lane of the dual lane gas press 120 (or tilt press 200) as depicted in FIG. 3.

Dual lane gas press 120 (may include tilt press 200) two press portions 144 each of which receives two spacer applied lites 146 with the spacer applied sides facing inwardly. Options for the structure of each gas press of dual lane gas press are further discussed elsewhere herein. Gas press 120 may include tilt press 200 described elsewhere in this application.

Two position shuttle 122 follows dual lane gas press 120 (or tilt press 200) and generally includes a shuttle structured to receive completed insulated glass units from dual lane gas press 120 (or tilt press 200). Two position shuttle 122 is further structured to deliver insulated glass units to queue conveyor 124. Queue conveyor 124 is structured to convey insulated glass units to sealer infeed 126. Sealer infeed 126 feeds insulated glass units to secondary sealer 128.

Secondary sealers 128 are known to those skilled in the art and may take many forms. In an example embodiment, secondary sealer 128 includes two sealant applicator heads 148 and two sealant pumps 150 each of which supplies sealant to one of the sealant applicator heads 148. According to an example embodiment of the invention, first sealant head applies secondary sealant to a first vertical side, top edge and second vertical side of an insulated glass unit while a second sealant head sealant head applies secondary sealant to a bottom of the insulated glass unit as it passes through secondary sealer 128. This particular sequence should not be considered limiting as there are many types of secondary sealer 128 known to those skilled in the art.

Sealer outfeed 130 is structured to receive a completed secondary sealed insulated glass unit from secondary sealer 128. Sealer outfeed 130 provides access to completed insulated glass units for removal and storage or further processing.

Referring now to FIG. 2, two spacer applied lites 152 are depicted including TPS material 154 applied. It is notable that the spacer applied lites 152 have TPS material 154 applied to a thickness approximating half the thickness of desired IGU spacer thickness on outwardly facing surfaces of spacer applied lites 152.

Referring now to FIG. 3, spacer applied lites 152 with TPS material 154 are depicted inside two lanes of dual lane gas press 120 (which may include tilting gas press 200). It is notable that the spacer applied lites 152 are placed in dual lane gas press 120 with the TPS material 154 facing inwardly toward another spacer applied lite 152. Accordingly, the relative positions of spacer applied lites 152 must be changed prior to or during placement in dual lane gas press 120.

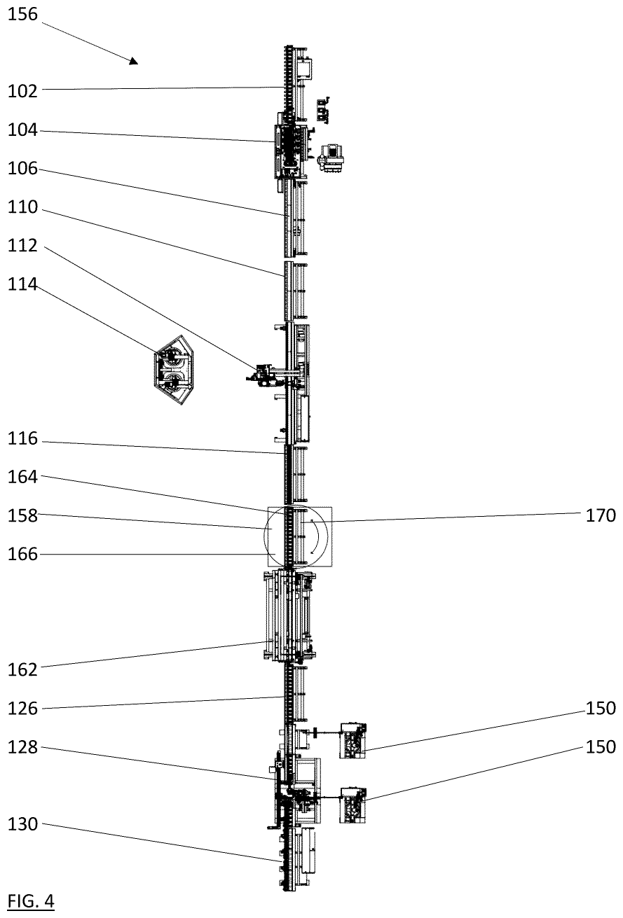

Referring particularly to FIG. 4, according to another example embodiment of the invention, cohesive bonding manufacturing line 156 generally includes input conveyor 102, lite washer 104, output conveyor 106, inspection station 110, thermoplastic spacer applicator robot 112, TPR feed systems 114, grid station 116, rotating shuttle conveyor 158, optionally dual lane V frame queue conveyor (not shown), gas press 162 (which may include tilting gas press 200), queue conveyor 124, sealer infeed 126, secondary sealer 128, and sealer outfeed 130. Individual elements of cohesive bonding manufacturing line 156 that are similar in design and structure to those described in cohesive bonding manufacturing line 100 are designated by similar reference numerals in FIG. 4 and are as described above.

Lites are loaded at input conveyor 102 which conveys them to lite washer 104 where they are washed and dried and then to output conveyor 106. Lites are conveyed to inspection station 110 and then to thermoplastic spacer applicator robot 112 fed by TPR feed systems 114. Spacer applied lites are then moved to grid station 116 prior to being loaded onto rotating shuttle conveyor 158.

Rotating shuttle conveyor 158 generally includes conveyor portion 164 and rotating table 166. In the depicted embodiment, conveyor portion 164 is situated on top of and supported by rotation table 166. Conveyor portion 164 is structured to be capable of conveying lites in either direction and receiving lites at either end. In an example embodiment, conveyor portion 164 includes a single lite conveyor 170 structured to support a single spacer applied lite with thermoplastic spacer material applied thereto. Single lite conveyor 170 is offset from a vertical axis of rotation so that in a first orientation conveyor portion 164 is aligned with gas press 162 which may include tilt press 200.

In an embodiment not depicted, in a first orientation conveyor portion 164 is aligned with first lane (not shown) of dual lane V frame queue conveyor (not shown) and in a second orientation is aligned with second lane (not shown) of dual lane V frame queue conveyor (not shown).

Rotation table 166 is structured to be capable of rotating at least one hundred eighty degrees for example three hundred sixty degrees.

Dual Lane V frame queue conveyor (not shown) includes two lanes including first lane (not shown) and second lane (not shown) that are opposed to each other and that are closer together at a bottom thereof than at a top thereof. When spacer applied lites are transferred from rotating shuttle conveyor 158 to dual lane. V frame queue conveyor (not shown) they are positioned with spacer applied sides facing inwardly.

Gas press 162 is structured to receive spacer applied lites from rotating shuttle conveyer or from dual Lane V frame queue conveyor (not shown) and to mate two spacer applied lites spacer applied sides together as will be further described. Gas press 162 is also structured to fill the space between the two spacer applied lites with a non-air gas as is known to those skilled in the art. Thus, gas press 162 gas fills, mates and presses the lites together to form an insulated glass unit. Gas press 162 may include tilt press 200 further described below.

The insulated glass unit is then fed to queue conveyor 124 and then to sealer infeed 126, secondary sealer 128, and sealer outfeed 130.

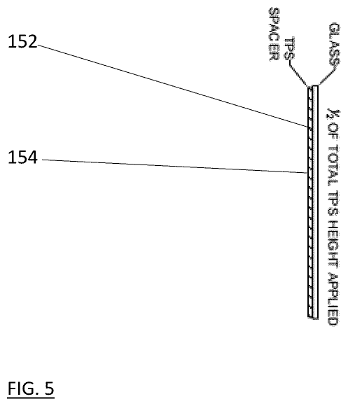

Referring to FIG. 5, according to this example embodiment, TPS is applied to each lite individually to approximately half the desired primary seal spacer height and alternate lites are rotated about a vertical axis to opposing orientations.

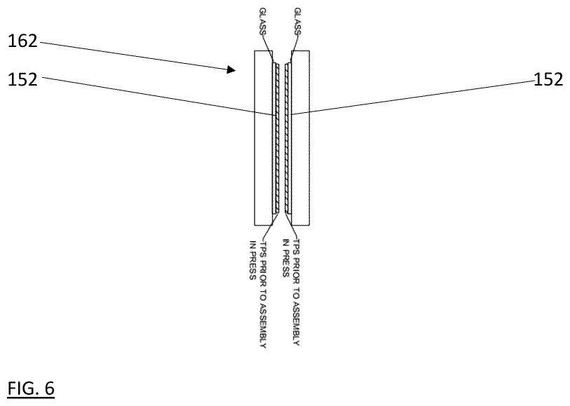

Referring to FIG. 6, according to this example embodiment in gas press 162 spacer applied lites are mated, spacer applied sides together and pressed to form an IGU.

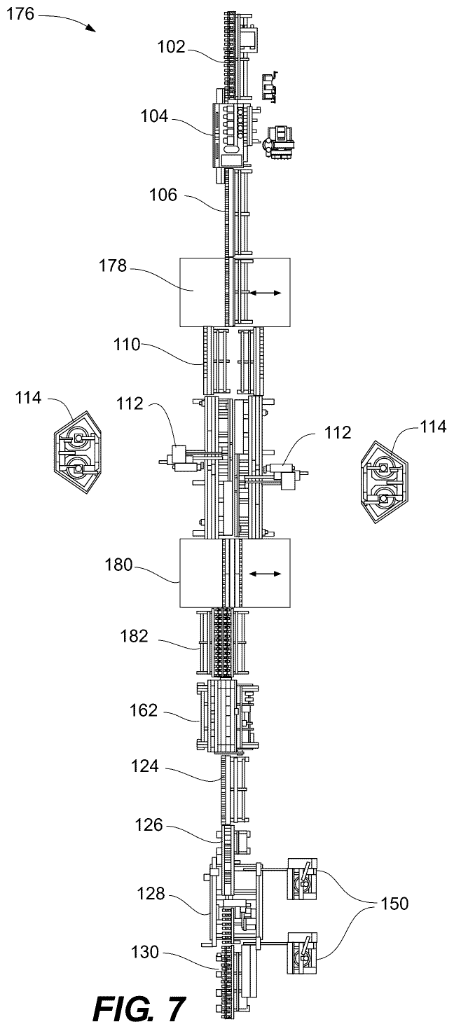

Referring to FIG. 7, according to another example embodiment of the invention, cohesive bonding manufacturing line 176 generally includes in sequence, input conveyor 102, lite washer 104, output conveyor 106, single lane two position shuttle 178, inspection conveyor/station 110, thermoplastic spacer applicator robot 112, TPR feed systems 114, dual lane A-frame shuttle/grid station 180, dual lane V frame queue station 182, gas press 162, queue conveyor 124, sealer infeed 126, secondary sealer 128, and sealer outfeed 130. Individual elements of cohesive bonding manufacturing line 176 that are similar in design and structure to those described in cohesive bonding manufacturing line 100 and/or cohesive bonding manufacturing line 156 are designated by similar reference numerals in FIG. 7 and are as described above.

Single lane two position shuttle 178 receives lites from output conveyor 106 and is configured to shuttle lites and distribute them alternately to two positions of inspection conveyor/station 110. Single lane two position shuttle 178 travels generally perpendicular to a long axis of cohesive bonding manufacturing line 176 while being structured to convey lites parallel to cohesive bonding manufacturing line 176.

Dual lane A-frame shuttle/grid station 180 is structured to support two spacer applied lites received in an A-frame orientation and includes two conveyor portions 184. That is, so that spacer applied lites received from thermoplastic spacer applicator robot 112 are oriented so that spacer applied sides are facing outwardly in opposing directions and so that the lites are closer together at a top thereof than at a bottom thereof. Dual lane A-frame shuttle/grid station 180 shuttles generally perpendicular to a long axis of cohesive bonding manufacturing line 176 and between at least two positions relative to dual lane V frame queue station 182 and at least two positions of thermoplastic spacer applicator robot 112. In so operating, dual lane A-frame shuttle/grid station 180 changes the orientation of shuttled lites from spacer applied lites the spacer applied side of which face away from each other to spacer applied lites the spacer applied side of which face toward each other.

Dual lane V-frame queue station 182, includes two conveyor portions 184 each of which is oriented closer together at a bottom thereof than at a top thereof and which are configured to support spacer applied lites with spacer applied sides facing inwardly. This orientation facilitates transfer to gas press 162 which is configured to facilitate gas filling, mating and pressing of spacer applied lites. According to this example embodiment on gas press 162 spacer applied lites are mated, spacer applied sides together and pressed to form an IGU. The IGU is then transported to queue conveyor 124 which conveys the lites to sealer infeed 126 and then to secondary sealer 128 as described above. A secondary sealed IGU is then conveyed to sealer outfeed 130 for removal and transport to another location for storage or further processing.

Referring to FIG. 6, gas press 162 is schematically depicted with two spacer applied lites therein prior to being pressed to form an IGU.

Referring to FIG. 7, according to another example embodiment, cohesive bonding manufacturing line 100 generally includes input conveyor 102, lite washer 104, outfeed or output conveyor 106, inspection station 110, thermoplastic spacer applicator robot 112, TPR feed systems (not shown), grid station 116, glass rotation station 192, gas press 162, queue conveyor 124, sealer in feed 126, secondary sealer 128 and sealer outfeed 130. It is expected that this embodiment will have a cycle time of about forty five seconds.

FIG. 8 depicts a conventional TPS IGU on the left demonstrating that a maximum thickness of spacer material 154 is typically limited to about twenty millimeters. Thus, a maximum IGU a gas space is limited similarly. A cohesively bonded TPS IGU can have a spacer thickness of approximately forty millimeters and thus a gas space of a similar thickness. A thicker gas space facilitates greater insulation value.

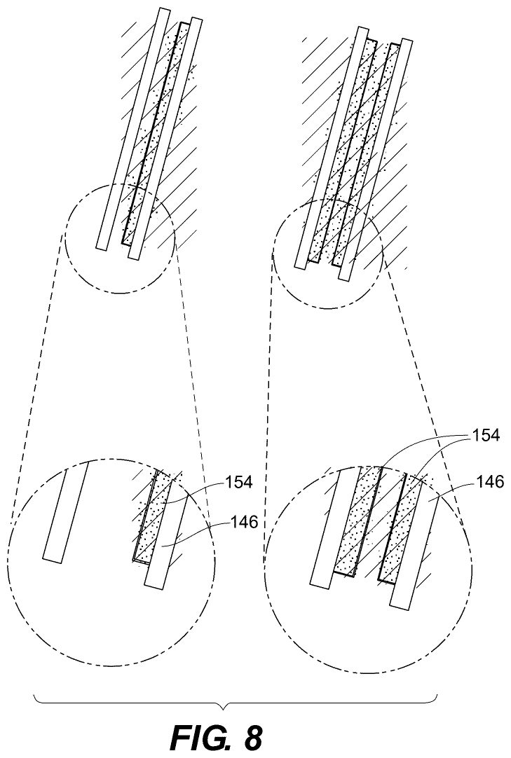

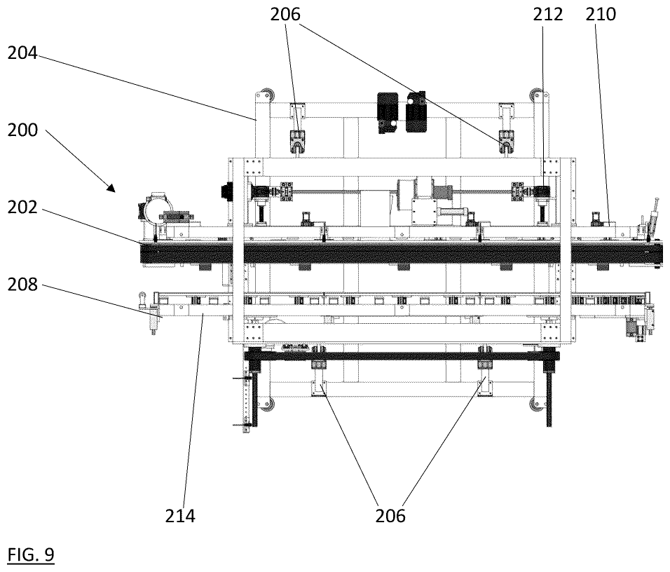

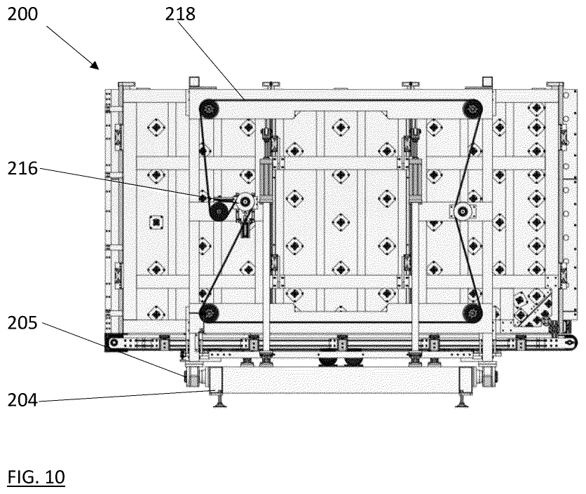

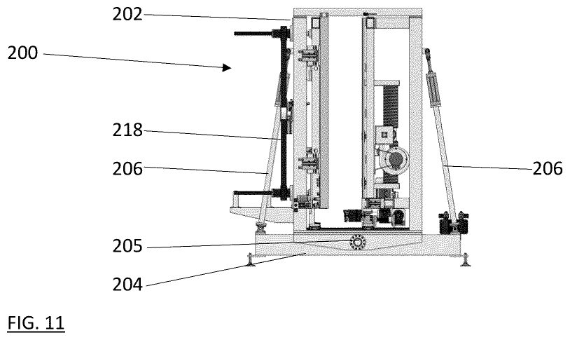

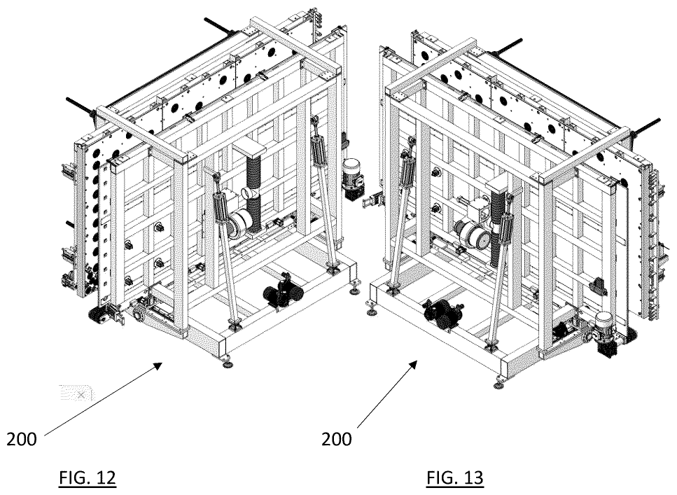

Referring to FIGS. 9-13, tilt press 200 generally includes tilt platen assembly 202 and supporting base 204. Tilt platen assembly 202 tilts about horizontal tilt axle 205 coupling tilt platen assembly 202 to supporting base 204 and is moved by at least one linear actuator 206 that further couples tilt platen assembly 202 to supporting base 204. Tilt platen assembly 202 tilts between a first orientation and a second orientation on either side of absolute vertical such as plus or minus twelve degrees. For example, the first orientation and the second orientation may be six degrees on either side of vertical.

According to an example embodiment, the at least one linear actuator 206 includes four pneumatic linear actuators 206, two on either side of tilt platen assembly 202. Tilt platen assembly 202 includes platen press 208 as known to those skilled in the art. Platen press 208 includes at least one movable platen 210 configured to press an IGU to facilitate cohesive bonding of TPS material 154 on two spacer applied lites. Platen press 208 includes gas filling structures as familiar to those skilled in the art. Moveable platen 210 may be moved for example by jack screws 212 toward and away from fixed platen 214. In the depicted embodiment, jackscrews 212 may be driven for example by motor 216 via serpentine belt 218.

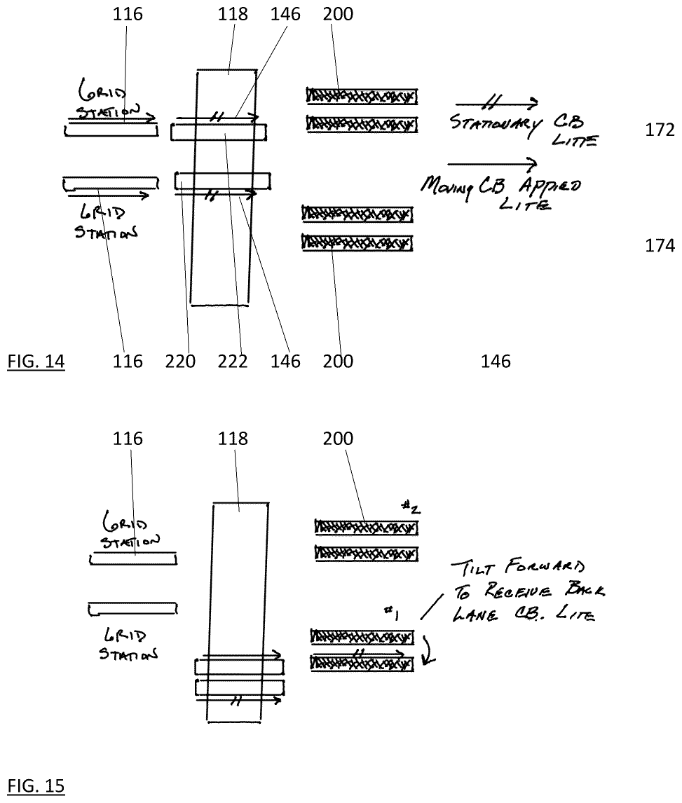

Referring to FIGS. 14-19, in operation, a sequence of events in the processing of insulated glass units is schematically depicted. In FIGS. 14-16 two tilt presses 200 are depicted schematically in plan view following grid stations 116 and independently positioned shuttle 118. Independently positioned shuttle 118 includes front shuttle 220 and rear shuttle 222. These are arranged into first lane 172 and second lane 174. FIGS. 17-19 depict these same structures and additionally depict two position shuttle 122. Not shown following two position shuttle 122 is secondary sealer 128. The progression to load spacer applied lites 146 to produce cohesively bonded insulated glass units is depicted in the context of tilting presses 200 as discussed above.

Referring to FIG. 14, independently positioned shuttle 118 receives front lane spacer applied lite 146 from first lane 172 and back lane spacer applied lite 146 from second lane 174 grid station 116. Independently positioned shuttle 118 shuttles spacer applied lites 146 backwards and forwards to align with tilt presses 200 of first lane 172 and second lane 174.

Referring to FIG. 15, independently positioned shuttle 118 moves to load spacer applied lites 146 into tilting press 200 of first lane 172. Front tilting press 200 of first lane 172 tilts forward to receive back lane spacer applied lite 146 taken from grid station 116 at second lane 174 by front shuttle 220. Back lane spacer applied lite 146 is loaded into tilting press 200 with spacer applied side 142 facing inwardly.

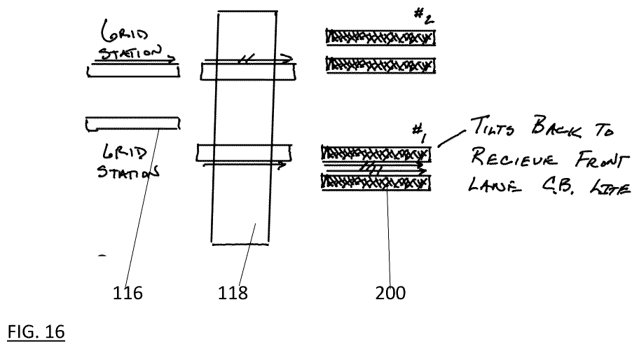

Referring to FIG. 16, rear shuttle 218 then returns to its starting position aligned with grid station 166 of second lane 174 to receive a further spacer applied lite 146. Tilt press 200 of first lane 172 tilts backward to receive spacer applied lite 146 from first lane 172 and from front shuttle 220. Meanwhile, rear shuttle 218 loads spacer applied lite 146 from second lane 174.

Referring to FIG. 17, tilt press 200 tilts forward to load second lane 174 spacer applied lite 146 with spacer applied side 142 facing inwardly which is received from rear shuttle 222. Meanwhile tilt press 200 associated with first lane 172 offloads a completed primary sealed insulated glass unit to two position shuttle 122. Front shuttle 220 loads spacer applied lite 146 from first lane 172.

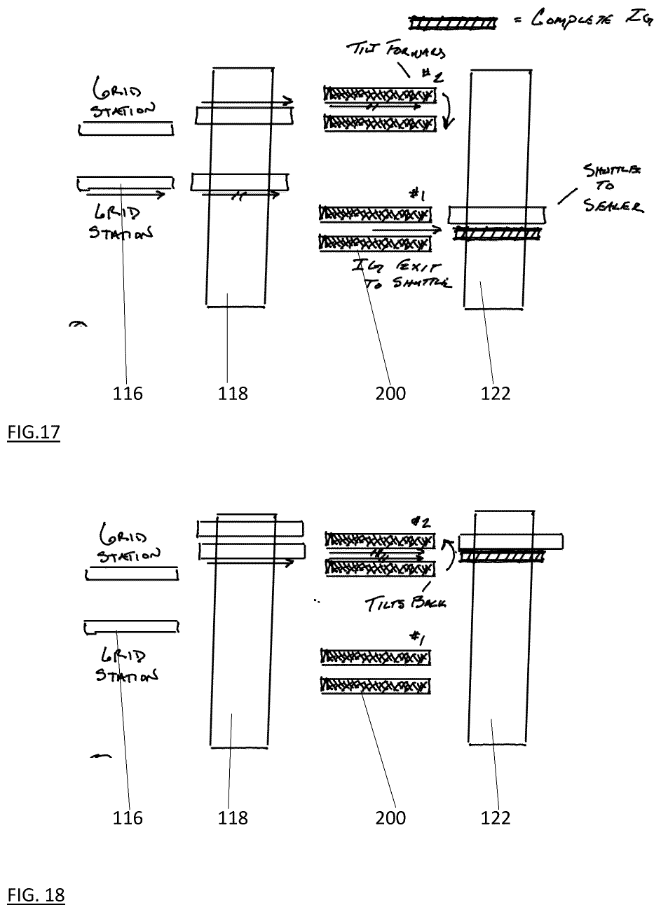

Referring to FIG. 18, tilt press 200 associated with second lane 174 tilts back to receive spacer applied lite 146 from front shuttle 216. Then, tilt press 200 associated with second lane 174 assembles, gas fills and presses the two spacer applied lites 146 to form a completed primary sealed insulated glass unit and sends primary sealed insulated glass unit out to two position shuttle 122.

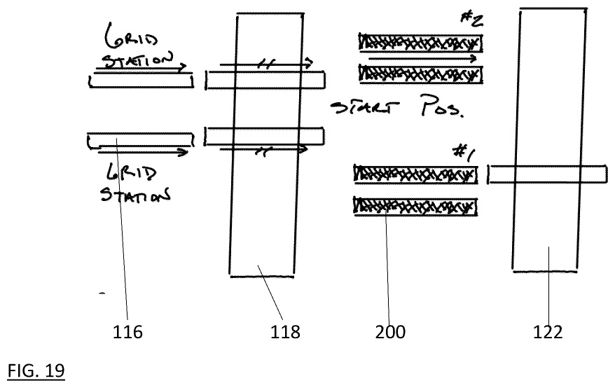

Referring to FIG. 19, both gas press assembly and sealer shuttle return to their starting position to begin the process of loading tilt press 200 press again. And the sequence repeats.

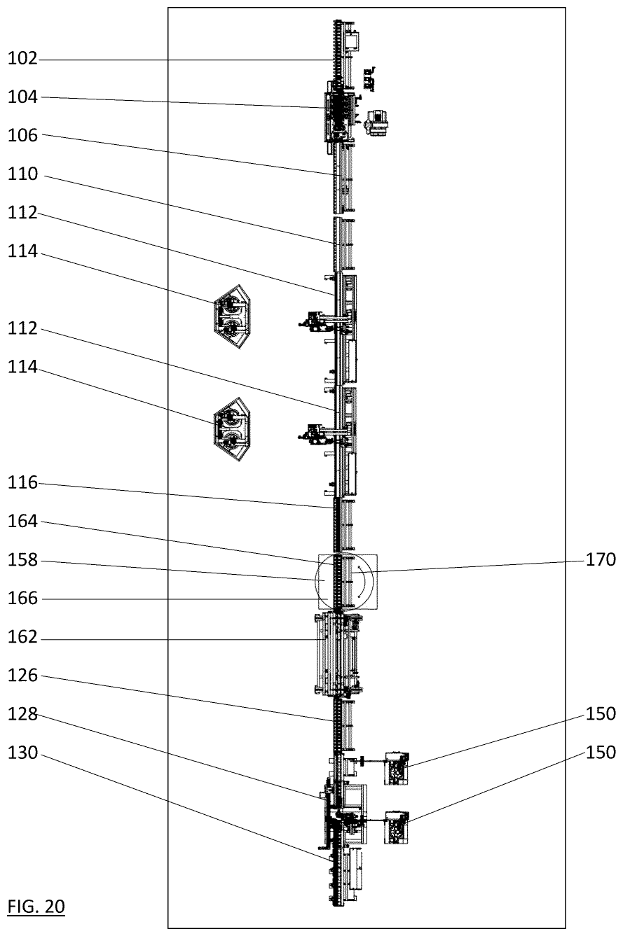

Referring particularly to FIG. 20, according to another example embodiment of the invention, dual applicator cohesive bonding manufacturing line 224 generally includes input conveyor 102, lite washer 104, output conveyor 106, inspection station 110, two thermoplastic spacer applicator robots 112, two TPR feed systems 114, grid station 116, rotating shuttle conveyor 158, optionally dual lane V frame queue conveyor (not shown), gas press 162 (which may include tilting gas press 200), queue conveyor 124, sealer infeed 126, secondary sealer 128, and sealer outfeed 130. Individual elements of cohesive bonding manufacturing line 224 that are similar in design and structure to those described in cohesive bonding manufacturing line 100 are designated by similar reference numerals in FIG. 20 and are as described above.

Lites are loaded at input conveyor 102 which conveys them to lite washer 104 where they are washed and dried and then to output conveyor 106. Lites are conveyed to inspection station 110 and then to thermoplastic spacer applicator robots 112 fed by TPR feed systems 114. Two spacer applied lites are delivered in tandem to two thermoplastic spacer applicator robots 112 and thus can have thermoplastic spacer material applied to them sequentially but nearly simultaneously. Spacer applied lites are then moved to grid station 116 prior to being loaded onto rotating shuttle conveyor 158 for optional application of grids. According to this example embodiment, the application of thermoplastic spacer material to two spacer applied lites nearly simultaneously by two thermoplastic spacer applicator robots 112 expedites the production of insulated glass units.

Rotating shuttle conveyor 158 generally includes conveyor portion 164 and rotating table 166. In the depicted embodiment, conveyor portion 164 is situated on top of and supported by rotation table 166. Conveyor portion 164 is structured to be capable of conveying lites in either direction and capable of receiving lites at either end thereof. In an example embodiment, conveyor portion 164 includes a single lite conveyor 170 structured to support a single spacer applied lite with thermoplastic spacer material applied thereto. Single lite conveyor 170 is offset from a vertical axis of rotation so that in a first orientation conveyor portion 164 is aligned with gas press 162 which may include tilt press 200.

Rotation table 166 is structured to be capable of rotating at least one hundred eighty degrees, for example three hundred sixty degrees.

Gas press 162 is structured to receive spacer applied lites from rotating shuttle conveyer and to mate two spacer applied lites spacer applied sides together as is further described elsewhere in this application. Gas press 162 is also structured to fill the space between the two spacer applied lites with a non-air gas as is known to those skilled in the art. Thus, gas press 162 gas fills, mates and presses the lites together to form an insulated glass unit. Gas press 162 may include tilt press 200 further described herein.

The insulated glass unit is then fed to queue conveyor 124 and then to sealer infeed 126, secondary sealer 128, and sealer outfeed 130 as described elsewhere herein.

1. An insulated glass unit, comprising:
two spacer applied lites including a first lite and a second lite each of which has a strand of thermoplastic spacer material applied thereto proximate and inset from a perimeter of each of the spacer applied lites including a first strand applied to the first lite and a second strand applied to the second lite;
wherein the first strand and the second strand are joined together and cohesively bonded by contact between the first strand and the second strand thereby forming a primary seal of the insulated glass unit.

2. The insulated glass unit as claimed in claim 1, further comprising grid clips embedded in the thermoplastic spacer material between the first strand and the second strand or further comprising grid members coupled to the grid clips and located between the two spacer applied lites or both.

3. The insulated glass unit as claimed in claim 2, wherein the first strand and the second strand of thermoplastic spacer material are of equal height.

4. The insulated glass unit as claimed in claim 1, further comprising a secondary sealant at least partially filling a space bounded on three sides by a peripheral portion of the first spacer applied lite, by a peripheral portion of the second spacer applied lite and the thermoplastic spacer material proximate the perimeter of insulated glass unit.

5. The insulated glass unit as claimed in claim 1, further comprising a non-air gas at least partially filling a space between the two spacer applied lites and bounded by the thermoplastic spacer material.

6. A method of making an insulated glass unit, comprising:
applying a first strand of thermoplastic spacer material around and in contact with a first perimeter of a first glass lite;
applying a second strand of thermoplastic spacer material around and in contact with a second perimeter of a second glass lite;
orienting the first glass lite and the second glass lite so that the first strand of thermoplastic spacer material of the first glass lite is facing the second strand of thermoplastic spacer material of the second glass lite; and
pressing the first glass lite and the second glass lite toward each other so that the first strand of thermoplastic spacer material contacts the second strand of thermoplastic spacer material and the first strand of thermoplastic spacer material and the second strand of thermoplastic spacer material cohesively bond together.

7. The method as claimed in claim 6, further comprising embedding grid clips embedded in the thermoplastic spacer material between the first strand and the second strand or further comprising inserting grid members coupled to the grid clips and locating the grid members between the two spacer applied lites and within the thermoplastic spacer material or both.

8. The method as claimed in claim 7, further comprising applying the first strand and the second strand of thermoplastic spacer material at an equal height.

9. The method as claimed in claim 1, further comprising applying a secondary sealant filling a space bonded on three sides by a peripheral portion of the first spacer applied lite, by a peripheral portion of the second spacer applied lite and the thermoplastic spacer material. around the perimeter of insulated glass unit.

10. An insulated glass unit manufacturing line, comprising:
at least one thermoplastic spacer robot applicator coupled to and supported by a thermoplastic robot feed system including at least one pump, the thermoplastic spacer robot applicator being structured to apply thermoplastic spacer material to a spacer applied side of a lite to create a spacer applied lite;
at least one structure configured to orient two of the spacer applied lites so that the spacer applied sides of the two spacer applied lites face one another;
at least one gas press that receives the two spacer applied lites and presses the two spacer applied lites together to create a primary sealed insulated glass unit.

11. The insulated glass unit manufacturing line as claimed in claim 10, further comprising at least one of:
an input conveyor;
a lite washer;
an output conveyor;
a quality scanner;
an inspection station;
a single lane two position shuttle;
a grid application station;
a dual lane shuttle;
a dual lane A-frame four position shuttle;
a dual lane gas press;
at least one tilting gas press;
a two position shuttle;
a queue conveyor;
a sealer infeed station;
a secondary sealer; and
a sealer outfeed station.

12. The insulated glass unit manufacturing line as claimed in claim 10, wherein the at least one structure configured to orient two of the spacer applied lites so that the spacer applied sides of the two spacer applied lites face one another, comprises:
a dual lane four position shuttle.

13. The insulated glass unit manufacturing line as claimed in claim 10, wherein the at least one structure configured to orient two of the spacer applied lites so that the spacer applied sides of the two spacer applied lites face one another, comprises:
a rotating shuttle conveyor.

14. The insulated glass unit manufacturing line as claimed in claim 10, wherein the rotating shuttle conveyor further comprises a conveyor portion and a rotating table portion.

15. The insulated glass unit manufacturing line as claimed in claim 10, wherein the at least one structure configured to orient two of the spacer applied lites so that the spacer applied sides of the two spacer applied lites face one another, comprises:
at least one independently positioned shuttle; or
a dual lane a-frame shuttle/grid station and a dual lane v-frame queue station.

16. The insulated glass unit manufacturing line as claimed in claim 10, further comprising at least one tilt press.

17. The insulated glass unit manufacturing line as claimed in claim 16, wherein the at least one tilt press further comprises a tilt platen assembly and a supporting base.

18. The insulated glass unit manufacturing line as claimed in claim 17, wherein the tilt platen assembly is coupled to the supporting base by a horizontal tilt axle and at least one linear actuator.

19. The insulated glass unit manufacturing line as claimed in claim 17, wherein the tilt platen assembly further comprises a moveable platen, a fixed platen and at least one jack screw operably coupled to the moveable platen whereby the moveable platen is moveable relative to the fixed platen.

20. The insulated glass unit manufacturing line as claimed in claim 10, wherein the at least one gas press further comprises a dual lane gas press or a tilting gas press.
